(19) United States
(12) Patent Application Publication
(10) Pub. No.: US 2026/0145215 A1
(43) Pub. Date: May 28, 2026

(54) COOLING MODULE, COOLING ASSEMBLY, COOLING SYSTEM, METHOD, HOT-ROLLED METAL STRIP-SHAPED PRODUCT, AND USE

(71) Applicant: SMS GROUP GMBH, Mönchengladbach (DE)

(72) Inventors: August SPROCK, Mönchengladbach (DE); Christoph HASSEL, Duisburg (DE); Ulrich CRAMER, Attendorn (DE); Henning BERG, Kreuztal (DE)

(21) Appl. No.: 19/124,168

(22) PCT Filed: Oct. 25, 2023
(86) PCT No.: PCT/EP2023/079782

§ 371 Date: Apr. 24, 2025

(30) Foreign Application Priority Data
Oct. 26, 2022 (DE) 10 2022 128 358.5

(51) Int. Cl. B21B 45/02; B21B 1/22

(52) U.S. Cl. CPC B21B 45/0209; B21B 1/22

(57) ABSTRACT

A cooling module of a cooling device for cooling a hot-rolled metal strip-shaped product using a coolant, the cooling module includes at least one cooling bar including a coolant chamber and a plurality of coolant outlet pipes connected to the coolant chamber to fluidically communicate therewith and each include at least one coolant outlet opening for applying the coolant to the strip-shaped product; at least one coolant feed connected to the coolant chamber to fluidically communicate therewith, the coolant feed is configured to connect to a coolant reservoir to fluidically communicate therewith, the coolant reservoir is configured to provide a pressure difference between the coolant reservoir and the coolant outlet opening; and at least one coolant valve arranged between the coolant feed and the coolant chamber; wherein the cooling module further includes time-variant behavior of a coolant rate in the coolant outlet opening.

The invention relates to a cooling module, a cooling group, a cooling system, a method, a hot-rolled metal strip-shaped product and a use.

The cooling module described here for cooling a strip-shaped product, in particular a hot-rolled metal strip-shaped product, comprises at least one cooling bar having a coolant chamber and a plurality of coolant outlet pipes communicatively connected to the coolant chamber for applying a liquid coolant to the strip-shaped product and can be used to cool said product.

For the production of flat or strip-shaped metal products, in particular metal strips or metal sheets, it is known to cool the metal products using cooling bars that extend across the width of a conveyor line along which the metal products are transported. For this purpose, the cooling bar can have a coolant chamber which is supplied with the liquid coolant and from which a plurality of coolant outlet pipes lead off in order to allow the coolant to leave, in particular for applying the coolant to the strip-shaped product. Such cooling bars can be a component of a cooling module and/or a cooling group and/or a cooling system.

The object of the invention is that of providing an improvement over or an alternative to the prior art.

According to a first aspect of the invention, the object is achieved by a cooling module of a cooling device for cooling a hot-rolled metal strip-shaped product using a coolant, comprising:
at least one cooling bar having a coolant chamber and a plurality of coolant outlet pipes that are connected to the coolant chamber so as to fluidically communicate therewith and each have at least one coolant outlet opening for applying the coolant to the strip-shaped product;
at least one coolant feed connected to the coolant chamber so as to at least indirectly fluidically communicate therewith, the coolant feed being configured to be connected to a coolant reservoir so as to at least indirectly fluidically communicate therewith, the coolant reservoir being configured to provide a pressure difference between the coolant reservoir and the coolant outlet opening; and
at least one coolant valve, the coolant valve being arranged between the coolant feed and the coolant chamber;
the cooling module having, under the influence of the pressure difference, time-variant behavior of a coolant rate in the coolant outlet opening when the coolant valve is fully opened in a step-like manner, which behavior can be described using a time-variant step function having a delay time and an equalization time; and
the sum of the delay time and the equalization time being less than or equal to 3.0 s, preferably less than or equal to 2.0 s and particularly preferably less than or equal to 1.5 s.

In this regard, the following is explained conceptually:

It is first expressly noted that, in the scope of the present patent application, indefinite articles and numbers such as “one,” “two,” etc., should generally be understood as being “at least” statements, i.e., as “at least one . . . ,” “at least two . . . ,” etc., unless it is clear from the relevant context or it is obvious or technically compelling to a person skilled in the art that only “exactly one . . . ” “exactly two . . . ,” etc., can be meant.

In the context of the present patent application, the expression “in particular” is always to be understood in such a way that an optional, preferred feature is introduced with this expression. The expression is not to be understood as “specifically” or “namely.”

A “cooling device” can be understood as a system which is designed to cool a flat and/or strip-shaped metal product using a liquid coolant, in particular a hot-rolled metal strip-shaped product.

It is provided that the metal strip-shaped product can be conveyed on a conveyor line in a transport direction such that it can enter into an operative connection with the cooling device, in particular by an operative connection with a liquid coolant leaving the cooling device in a designated fashion. For this purpose, the metal strip-shaped product can be conveyed past at least one cooling bar of the cooling device and/or between at least two cooling bars of the cooling device.

The cooling device can have at least one cooling bar arranged above the metal strip-shaped product, in particular one or more first cooling bars to which the liquid coolant is supplied via a coolant feed, wherein the cooling bar preferably extends substantially transversely to the transport direction and preferably has a plurality of coolant outlet pipes via which the liquid coolant can be brought into an operative connection with the metal strip-shaped product.

Analogously, the cooling device can have at least one cooling bar arranged below the metal strip-shaped product, in particular one or more second cooling bars, designed to bring the liquid coolant into an operative connection with the metal strip-shaped product.

The cooling device can have a plurality of cooling bars which can be arranged above and/or below the metal strip-shaped product in the conveying direction of the metal strip-shaped product.

One or more cooling bars of a cooling device may be organized and/or arranged in one or more cooling modules and/or one or more cooling groups and/or one or more cooling systems.

While a cooling module can have a plurality of cooling bars which can be supplied with coolant at least indirectly via a common cooling module branch, a “cooling group” can have a plurality of cooling modules which can be supplied with coolant at least indirectly via a common cooling group branch. A plurality of cooling modules of a cooling group can in particular be operated with different setting values, in particular different volume flows of the liquid coolant flowing out of each associated coolant outlet opening.

In addition to at least one cooling module and/or at least one cooling group, a “cooling system” comprises at least one coolant reservoir and at least one “main coolant feed,” wherein the at least one main coolant feed is connected to the at least one coolant reservoir and the at least one cooling module and/or the at least one cooling group so as to at least indirectly fluidically communicate therewith.

Preferably, a cooling system comprises a master electronic open-loop and/or closed-loop control unit, wherein the master electronic open-loop and/or closed-loop control unit is configured to control the cooling system using open-loop and/or closed-loop control. The master electronic open-loop and/or closed-loop control unit can be configured to control at least one coolant valve using open-loop and/or closed-loop control. Alternatively, the master electronic open-loop and/or closed-loop control unit can form a data connection with at least one electronic open-loop and/or closed-loop control unit, wherein the electronic open-loop and/or closed-loop control unit is configured to control the cooling module and/or a cooling group using open-loop and/or closed-loop control.

A coolant reservoir is designed to store and/or provide coolant.

A “coolant” is understood to mean a fluid that can be used to cool the metal strip-shaped product, wherein the coolant can have different temperature-dependent states. In particular, the coolant can be a gaseous and/or liquid substance or a gaseous and/or liquid mixed substance. Here, it is provided that the coolant flows out of a coolant outlet opening at least predominantly in liquid form. A heat flow from the metal strip-shaped product to the coolant can cause the coolant to at least partially evaporate.

In the liquid state, the coolant is considered to be incompressible.

A “cooling bar” substantially consists of a substantially longitudinally extending coolant chamber, a plurality of coolant outlet pipes that are connected to the coolant chamber so as to fluidically communicate therewith and are arranged one behind the other or in successive pairs in the longitudinal direction of extension of the cooling bar, and a coolant inlet opening.

The “coolant chamber” is designed to relax the pressure of the coolant flowing into the cooling bar through the coolant inlet opening in a designated fashion, wherein a predominantly uniform division of a coolant volume flow from the coolant chamber to the coolant outlet pipes can be achieved. If a plurality of coolant outlet pipes directly fluidically connected to a coolant chamber are provided, means for hydraulic balancing can be provided at the transition between the cooling chamber and at least one coolant outlet pipe, which means is designed to harmonize the amount of the partial coolant volume flows flowing out of a plurality of coolant outlet pipes that are directly fluidically connected to the cooling chamber.

A “coolant outlet pipe” is understood to mean a tubular extension of the cooling bar which is designed to allow the coolant to leave the cooling bar through a “coolant outlet opening.” A coolant outlet pipe may preferably be welded or bolted to the coolant chamber or connected to the coolant chamber in some other way.

A coolant outlet pipe can extend in a straight line. Alternatively, a coolant outlet pipe may extend in a J shape and/or be shaped like a goose neck.

A “coolant valve” is understood to mean a device for controlling a flow rate of the coolant in a coolant cut-off region of the coolant valve using open-loop control, wherein a coolant cut-off region can be completely shut off.

A coolant valve can be at least indirectly electrically and/or electronically adjustable. In particular, a coolant valve can be designed as a coolant control valve which is configured to control a flow rate of the coolant at an externally set setpoint using closed-loop control.

A coolant valve may have a data interface configured to connect the coolant valve to an electronic data processing and evaluation unit, wherein the electronic data processing and evaluation unit is configured to control the coolant valve using open-loop and/or closed-loop control.

Preferably, the largest possible free cross section of a coolant valve, in particular the a coolant cut-off region, is greater than or equal to a nominal diameter of a coolant feed and/or a nominal diameter of a coolant inlet opening of a cooling bar and/or a nominal diameter of a coolant chamber of a cooling bar.

A “cooling module” is understood to mean a unit consisting of at least one cooling bar, at least one coolant valve and at least one “coolant feed” for supplying the cooling module with coolant.

Preferably, exactly one coolant valve is at least indirectly fluidically connected to exactly one cooling bar.

A “coolant feed” can be understood as a region of a coolant guiding means which is directly fluidically connected to a coolant valve, in particular an inlet region of the coolant valve, in particular a free cross section of a coolant valve flange, in particular of the coolant valve flange which is arranged on the side complementing the side of the coolant valve which is in fluid communication with the cooling bar. Alternatively, a coolant feed can be understood as a region of a coolant pipe which is directly fluidically connected to the coolant valve.

A coolant feed can be configured to be at least indirectly fluidically connected to a coolant reservoir for storing and/or providing coolant.

A “pressure difference” is understood to mean a total pressure difference between the level of the coolant reservoir and a coolant outlet opening of a cooling module.

In the case of a connection between the coolant reservoir and at least one coolant outlet pipe through which the coolant can pass, the total pressure difference can result from a difference in the geodetic level between the level of the coolant reservoir and a coolant outlet opening of a cooling module and/or from pressure losses between the coolant reservoir and the coolant outlet opening of the cooling module and/or a pressure change using a conveying device, in particular a main coolant conveying device.

Preferably, the pressure difference is greater than or equal to 3·10⁵ kg/(m·s²), more preferably the pressure difference is greater than or equal to 4·10⁵ kg/(m·s²), preferably the pressure difference is greater than or equal to 5·10⁵ kg/(m·s²) and particularly preferably the pressure difference is greater than or equal to 6·10⁵ kg/(m·s²).

A “coolant rate” is understood to mean the cross-sectional average rate in a reference cross section of the cooling device between the coolant reservoir and a coolant outlet opening of a cooling module.

Preferably, the coolant rate means the average rate in a coolant outlet opening of a cooling module.

“Time-variant behavior” means system behavior whose system response is dependent both on the time of observation and on the time of a step-like change in a manipulated variable at the system input. In particular, the coolant rate in a coolant outlet opening of the cooling module depends on a coolant valve setting, in particular a step-like adjustment of the coolant valve, and the effective pressure difference.

A “time-variant step function” of the coolant rate over time describes the course of the coolant rate in a coolant outlet opening of the cooling module as a function of time after the coolant valve corresponding to the coolant outlet opening has been opened in a step-like manner, wherein a steady state is set as the system response after a certain amount of time.

When evaluating the time-variant system behavior on the basis of the time course until the steady state is reached, an equalization time and/or a delay time can in particular be considered as system-dependent, and thus characteristic, variables of the time-variant step function. The time-variant system behavior can be used to describe a closed-loop control system with regard to closed-loop control, in particular with regard to the closed-loop control of a cooling module.

The “delay time” can represent a measure of the higher-order influences on the time-variant system behavior and results from the time-variant step function by means of the following steps:
determining the inflection point of the time-variant step function, in particular the coolant rate
drawing a tangent through the inflection point of the time-variant step function; and
determining the delay time as the difference between the time at which the tangent intersects the abscissa and the time of the step-like change in the manipulated variable, in particular of the coolant valve being opened in a step-like manner.

The “equalization time” can represent a measure of the inertia of the time-variant system behavior, i.e., a measure of the first-order influences on the time-variant system behavior, and results from the time-variant step function by means of the following steps:
determining the inflection point of the time-variant step function, in particular the coolant rate;
drawing a tangent through the inflection point of the time-variant step function;
determining an asymptote for the steady state of the time-variant system behavior that results after the step-like change in the manipulated variable; and
determining the equalization time as the difference between the time at which the tangent intersects the asymptote and the time at which the tangent intersects the abscissa.

A “cooling rate” is understood to mean the rate at which a hot-rolled metal strip-shaped product is cooled, wherein the cooling rate can be expressed as K/s. If a hot-rolled metal strip-shaped product is preferably cooled from an average temperature of 1,150 K with a constant cooling rate of 50 K/s, it will have an average temperature of 650° K after a cooling time of 10 s.

The cooling rate is, among other things, effectively linked to the amount of coolant and the thickness of the metal strip-shaped product. If the thickness of the metal strip-shaped product increases while all other variables remain constant, the cooling rate decreases as a result of temperature equalization processes in the metal strip-shaped product.

The course of the phase transformation of steel has an effect on the microstructure composition of steel. The microstructure composition of steel in turn affects the properties of steel.

The course of the phase transformation of steel is substantially determined by the cooling rate and the temporal progression of the cooling rate. Preferably, in a first cooling phase, the hot-rolled metal product is actively cooled to a first target temperature by a cooling system using a liquid coolant and, in a second cooling phase, the hot-rolled metal product passively cools down until it reaches ambient temperature. Furthermore, the hot-rolled metal product is preferably rolled up shortly after reaching the first target temperature.

The microstructure composition of steel, in particular the ferrite content and/or the pearlite content and/or the bainite content and/or the martensite content and/or the austenite content of the steel microstructure, and thus its material properties, results, among other things, from the cooling rate of the cooling system, the first target temperature up to which the steel is actively cooled and its alloy composition. Preferably, a cooling rate can be achieved that reduces or prevents pearlite precipitation, thereby reducing the hardness of the material and thus improving formability. Alternatively, a pearlite content in the metal microstructure can be achieved or specifically set with a comparatively lower cooling rate, which increases the hardness of the hot-rolled metal product.

Hot rolling a hot-rolled metal product is a predominantly continuous process, with the rolling stands being fixedly mounted and the metal product being conveyed through the rolling stands in order to be rolled. Accordingly, active cooling after rolling by means of a cooling system is also a continuous process in which the hot-rolled metal product is predominantly continuously conveyed past at least one stationary cooling bar of the cooling system and/or between at least two stationary cooling bars of the cooling system.

Accordingly, a plurality of coolant outlet openings are involved in the continuous active cooling process in the direction in which the metal strip-shaped product is conveyed past and/or through the cooling device of the cooling system, so that the course of the cooling rate and thus also the properties of the hot-rolled metal product in the conveying direction are influenced by a plurality of cooling bars and coolant outlet openings and each of the conveyed or exiting coolant variables.

In other words, there is an effective link between the properties of a hot-rolled metal product and the coolant volume flows flowing out of a plurality of coolant outlet openings, in particular the coolant volume flows flowing out of a plurality of coolant outlet openings arranged in the conveying direction, in particular the coolant volume flows flowing out of a plurality of coolant outlet openings of different cooling bars arranged in the conveying direction.

Tests have shown that an advantageous temporal progression of the cooling rate in the conveying direction of a hot-rolled metal product can reduce the content of cost-intensive alloying elements to achieve the same material properties. In this respect, it is particularly advantageous to be able to vary the temporal progression of the cooling rate quickly and/or precisely, in particular to be able to quickly and/or precisely vary it in a manner effectively linked to a plurality of cooling bars acting on the cooling rate.

The cooling rate is effectively linked to a plurality of physical effects, although only the effective links that have a particularly sensitive impact on the cooling rate will be discussed here.

Tests have shown it to be advantageous to be able to precisely control the cooling rate that is already effectively linked to a cooling bar, in particular to exactly one cooling bar, and thus with a stationary, designated coolant volume flow using open-loop and/or closed-loop control.

Furthermore, tests have shown that some effects physically effectively linked to the cooling rate are particularly dynamic, which means that it has unexpectedly proven to be particularly advantageous to be able to control a stationary designated coolant volume flow with improved dynamics using open-loop and/or closed loop control, in particular already effectively linked to a cooling bar, preferably to exactly one cooling bar.

The Leidenfrost effect forms a first effective link to high cooling rate dynamics. The temperature of the hot-rolled metal product before entering the cooling device is regularly above the Leidenfrost temperature, which can be between approximately 300 K and 600 K depending on the severity of a plurality of parameters. As a result, at least in the first region of the conveyor line for the hot-rolled metal product through the cooling device, a coolant vapor layer is formed between the hot-rolled metal product and the liquid coolant, which dampens the heat transfer coefficient and thus the cooling rate.

Unwanted total pressure fluctuations of the coolant on the top of the coolant vapor layer can lead to the layer breaking open in locally delimited regions, whereby, in a manner effectively linked to the evaporation enthalpy of the coolant acting directly on the hot-rolled metal product, the local cooling rate increases sharply for a short time in locally delimited regions and causes an inhomogeneity in the microstructure.

A second effective link consists in the compactness of the coolant volume flow flowing out of a coolant outlet opening. After the coolant has left a coolant outlet opening, after a decay time or, coupled with the rate of a coolant volume flow, after a decay length, the coolant volume flow may break up and thus lead to local pressure variations at the coolant vapor layer. If such an effect occurs, it also has particularly high dynamics.

It has been shown that a critical pressure variation of the coolant vapor layer can be advantageously reduced or prevented by a compact coolant volume flow that is as continuous as possible, provided that a local intervention on the local coolant volume flow can be carried out with sufficient precision and/or rate.

Atomization or rippling of the coolant volume flow after it has left the coolant outlet opening can also have a negative effect on the coolant vapor layer, and therefore physical links to the total pressure of the coolant upstream of the coolant outlet opening can also be relevant for achieving the most homogeneous cooling rate possible.

Further effective physical links to the cooling rate consists in the thickness and alloy composition of the hot-rolled metal product.

The effective links described above are at least partially systematically linked to one another in such a way that they have a mutual effect on one another. Even small disturbances during active cooling using the liquid coolant can lead to inhomogeneities in the local microstructure of the manufactured hot-rolled metal product, which can cause inhomogeneities in the material properties.

For material properties that are required for a metal strip-shaped product, minimum values are specified that must be met at every point in the product. Therefore, particularly good homogeneity of the microstructure of the metal strip-shaped product is advantageous and allows for a particularly significant saving with regard to cost-intensive alloy components.

In other words, a cooling rate that is as precise as possible and/or is maintained in the event of disturbances can enable a microstructure that is as homogeneous as possible and thus a reduction of cost-intensive alloy components for the metal strip-shaped product.

According to tests conducted, disturbance variables affecting the cooling rate can exhibit a high degree of temporal dynamics and thus cause highly resolved deviations from the desired microstructure.

Therefore, a cooling module is proposed here which has a coolant valve arranged between the coolant feed and the coolant chamber, wherein the coolant feed can be a component of the coolant valve, wherein the coolant feed is arranged on the side of the coolant cut-off region which is arranged on the side of the coolant cut-off region facing away from the coolant chamber.

Preferably, the coolant valve is directly fluidically connected to the coolant chamber, wherein less than one flow-guiding component is arranged between the coolant valve and the coolant chamber, in particular between the coolant valve and a one-piece coolant chamber. A one-piece cooling chamber can be understood to mean, among other things, a welded construction.

According to a preferred embodiment, less than one fluid branch is arranged between the coolant valve and the coolant chamber. In other words, the coolant valve can be fluidically connected to exactly one coolant chamber.

The fluid connection between the coolant valve and the coolant chamber can be designed such that the coolant valve ensures that only this coolant chamber can be supplied with a coolant.

The cooling module proposed here enables a designated coolant volume flow to be precisely set at a point in the conveyor line for the metal strip-shaped product determined by the position of the cooling bar due to its preferably direct assignment of the coolant valve and the coolant chamber of the cooling bar. This enables a high degree of spatial resolution with respect to the rate of cooling along the conveyor line for the metal strip-shaped product, passing at least one cooling module, and thus an increase in precision for the temporal progression of the temperature of the metal strip-shaped product, which influences the microstructure. Thus, in particular the accuracy with which the cooling module proposed here is set in particular enables cost-sensitive alloy components to be reduced while maintaining the same minimum required material properties of the metal strip-shaped product.

The coolant valve of the cooling module proposed here preferably acts only on one cooling bar. Accordingly, the amount of coolant downstream of the coolant valve up to the at least one coolant outlet opening, on which a setting and/or adjustment of the coolant valve preferably directly acts, is particularly small compared to previously known systems. In known cooling systems, a coolant valve acts on a plurality of cooling bars and thus also on a comparatively higher amount of coolant downstream of the coolant valve up to the at least one coolant outlet opening. Thus, the cooling module proposed here allows only a comparatively small amount of coolant to have to be accelerated when setting and/or adjusting the coolant valve. This results in a smaller inertial resistance due to the amount of cooling water to be accelerated. The inertial resistance has a damping effect on the time-variant behavior of the coolant rate in a coolant outlet opening of the cooling module. In other words, the cooling module proposed here can reduce the equalization time brought about by the cooling module. The cooling module proposed here thus enables a more dynamic response to any disturbances that may occur and allows disturbance variable-induced microstructure changes to be optimally reduced in their severity. This property of the cooling module proposed here can be used to reduce cost-sensitive alloy components while maintaining the same minimum required material properties of the metal strip-shaped product.

While the equalization time of the cooling module is substantially influenced by the inertia of the amount of coolant to be accelerated, the delay time is effectively linked to the effective acceleration due to gravity, the geodetic level difference between the coolant feed of the cooling module and the at least one coolant outlet opening of the cooling module as well as the total pressure losses in the cooling module between the coolant feed and the at least one coolant outlet opening. This can be seen from the following differential equation of a coolant particle in the cooling module:

$$\frac{{\partial }_{2} \vec{s}}{\partial {t}^{2}} = \frac{1}{2} ( \vec{g} + \frac{\sqrt{2 \vec{g} ( {h}_{1} - {h}_{2} ) + \frac{2}{ρ} ( {p}_{1} - {p}_{2} ) - \frac{2}{ρ} Δ {p}_{V 12}}}{t} ) \cdot {t}^{2} + \frac{\partial \vec{s}}{\partial t} \cdot t + \vec{{s}_{0}}$$

Here, \vec{s} is the location of the coolant particle, t the time, \vec{g} the local acceleration due to gravity, ρ the density of the coolant, h the geodetic level and p the total pressure, wherein the subscript indicates the respective locations such that Δp_{V12} describes the total pressure loss between location 1 and location 2, i.e., the sum of the individual total pressure losses between location 1 and location 2, in particular the total pressure losses caused by a coolant loss coefficient of a coolant valve and/or friction of a coolant line transporting coolant and/or a transition loss coefficient of a transition and/or a cooling module branch loss coefficient of a cooling module branch and/or a cooling group branch loss coefficient of a cooling group branch and/or the like.

The coolant is preferably water. The total pressure difference is preferably greater than or equal to

$$20 , 000 \frac{kg}{m \cdot {s}^{2}} ,$$

more preferably greater than or equal to

$$35 , 000 \frac{kg}{m \cdot {s}^{2}} ,$$

preferably greater than or equal to

$$45 , 000 \frac{kg}{m \cdot {s}^{2}}$$

and particularly preferably greater than or equal to

$$55 , 000 \frac{kg}{m \cdot {s}^{2}} .$$

Preferably, the sum of the delay time and the equalization time for the time-variant step function of the cooling module is less than or equal to 5.0 s, more preferably less than or equal to 2.5 s, preferably less than or equal to 1.5 s and particularly preferably less than or equal to 0.5 s.

The delay time for the time-variant step function of the cooling module can be greater than 0.0 s. Preferably, the delay time for the time-variant step function of the cooling module is less than or equal to 0.8 s, more preferably less than or equal to 0.5 s, preferably less than or equal to 0.3 s and particularly preferably less than or equal to 0.1 s.

The equalization time for the time-variant step function of the cooling module can be greater than 0.0 s. Preferably, the equalization time for the time-variant step function of the cooling module is less than or equal to 2.5 s, more preferably less than or equal to 2.0 s, preferably less than or equal to 1.5 s and particularly preferably less than or equal to 1.0 s.

The influence of the sum of the delay time and the equalization time of the cooling module on the achievable microstructure homogeneity and the corresponding scrap rate resulting from the required material specifications not being achieved together with a simultaneous reduction in the use of cost-sensitive alloying elements was investigated in tests and can be found in Table 1. It is evident that a reduction of the delay time and equalization time of the cooling module as a result of the structural design of the cooling module has an advantageous effect on the achievable microstructure homogeneity.

The microstructure homogeneity can be evaluated by the degree of division V_{g} of a microstructure component:

$${V}_{g} = 1 - \frac{σ}{\overline{c}} , where$$

$$σ = \sqrt{\frac{1}{N} {\sum }_{1}^{N} {( {c}_{i} - \overline{c} )}^{2}} ,$$

cᵢ corresponds to the concentration of the embedded microstructure component at the position i and c̅ corresponds to the average concentration of the microstructure component in the metal strip-shaped product.

TABLE 1
Sum of the delay time and equalization time of the cooling module,
achievable microstructure homogeneity, scrap rate; + means positive,
0 means neutral; the more + are shown, the more positive it is.

| Sum of delay time and | Microstructure | |
|---|---|---|
| equalization time | homogeneity | Scrap rate |
| 5.0 s | 0 | +++ |
| 3.0 s | + | ++++ |
| 2.5 s | ++ | +++++ |
| 2.0 s | +++ | +++++ |
| 1.5 s | ++++ | ++++++ |
| 1.0 s | +++++ | ++++++ |
| 0.5 s | ++++++ | ++++++ |

According to an expedient embodiment, the coolant valve has, under the influence of the pressure difference, time-variant behavior of the coolant rate in the coolant chamber when the coolant valve is fully opened in a step-like manner, which behavior can be described by a time-variant coolant valve step function having a coolant valve time constant, wherein the coolant valve time constant is less than or equal to 1.5 s, preferably less than or equal to 1.0 s and particularly preferably less than or equal to 0.5 s.

Preferably, the coolant valve time constant is less than or equal to 0.75 s, more preferably less than or equal to 0.35 s, preferably less than or equal to 0.25 s and particularly preferably less than or equal to 0.1 s.

In this regard, the following is explained conceptually:

A “time-variant coolant valve step function” describes an open state of the coolant valve between the coolant valve being fully closed and fully opened over time after the coolant valve has been fully opened in a step-like manner. Accordingly, after a certain amount of time, the coolant valve is in a state where it is completely open.

When evaluating the time-variant system behavior on the basis of the temporal progression until the steady state is reached, a “coolant valve time constant” in particular can be considered as a system-dependent, and thus characteristic, variable of the time-variant coolant valve step function. The time-variant system behavior can be used to describe a closed-loop control system with regard to closed-loop control, in particular with regard to the closed-loop control of a coolant valve.

A coolant valve can exhibit the time behavior of a first-order delay element. To determine the coolant valve time constant, reference is made to literature relating to the determination of a time constant for a first-order delay element, in particular by determining it from the standard differential equation describing the opening of the coolant valve.

The influence of the coolant valve time constant on the delay time of the cooling module was investigated in tests and can be found in Table 2. It was found that the coolant valve time constant of the coolant valve is effectively linked to the delay time of the cooling module.

TABLE 2
Coolant valve time constant of the coolant valve and delay
time of the cooling module; + means positive, 0 means
neutral; the more + are shown, the more positive it is.

| | |
|---|---|
| Coolant valve time constant | Delay time of the cooling module |

| | | |
|---|---|---|
| 1.5 | s | 0 |
| 1.0 | s | + |
| 0.75 | s | ++ |
| 0.5 | s | +++ |
| 0.35 | s | ++++ |
| 0.25 | s | +++++ |
| 0.1 | s | ++++++ |

When fully open, the coolant valve expediently has a coolant valve loss coefficient ζᵥₐₗᵥₑ of less than or equal to 0.46, preferably less than or equal to 0.44 and particularly preferably less than or equal to 0.24.

Preferably, when fully open, the coolant valve has a coolant valve loss coefficient ζᵥₐₗᵥₑ of less than or equal to 0.23, more preferably less than or equal to 0.22, preferably less than or equal to 0.21 and particularly preferably less than or equal to 0.19.

Further preferably, when fully open, the coolant valve has a coolant valve loss coefficient ζᵥₐₗᵥₑ of less than or equal to 0.15, more preferably less than or equal to 0.12, preferably less than or equal to 0.10 and particularly preferably less than or equal to 0.08.

In this regard, the following is explained conceptually:

The “coolant valve loss coefficient” ζᵥₐₗᵥₑ is understood to mean a dimensionless resistance coefficient for the coolant valve, which describes a measure of the pressure loss in the coolant valve through which the designated coolant flows when the coolant valve is fully open. The coolant cut-off region can be used as a reference cross section for the coolant valve loss coefficient which describes the cross section in the center of the coolant valve through which a coolant can flow when the valve is fully open, and through which the coolant cannot flow when the coolant valve is fully closed.

The coolant valve loss coefficient ζᵥₐₗᵥₑ can be determined as follows:

$${ζ}_{valve} = \frac{2 \cdot Δ p}{ρ \cdot {\overline{v}}_{valve}^{2}}$$

$${\overline{v}}_{valve}^{2}$$

is understood to mean the square of the area-averaged coolant rate in the reference cross section of the coolant valve, in particular in the coolant cut-off region. When coolant flows through the coolant valve, Δp describes the absolute pressure loss over the entire extent of the coolant valve in the designated flow direction and ρ describes the density of the coolant.

Tests have shown that the coolant valve loss coefficient is effectively linked to the delay time of the cooling module. It was found that the delay time of the cooling module can be reduced if the coolant valve has a smaller coolant valve loss coefficient. Accordingly, it is suggested here to select a coolant valve with a low coolant valve loss coefficient for the cooling module.

The coolant valve preferably has a nominal diameter of greater than or equal to DN80, preferably greater than or equal to DN150 and particularly preferably greater than or equal to DN200.

In this regard, the following is explained conceptually:

The “nominal diameter” of the coolant valve is understood to be the nominal diameter according to EN ISO 6708. The designation DN is followed by a dimensionless number that approximately corresponds to the internal diameter of the coolant valve in millimeters.

TABLE 3
Nominal width of the coolant valve, delay time of the cooling module,
equalization time of the cooling module; + means positive,
0 means neutral; the more + there are, the more positive it is.

| Nominal diameter of the | Delay time of the | Equalization time of the |
|---|---|---|
| coolant valve | cooling module | cooling module |
| DN60 | ++ | +++++ |
| DN80 | +++ | ++++ |
| DN120 | ++++ | +++ |
| DN150 | +++++ | ++ |
| DN200 | ++++ | + |
| DN250 | +++ | 0 |
| DN300 | ++ | 0 |

Preferably, the coolant valve has a nominal diameter of greater than or equal to DN60, more preferably greater than or equal to DN120, preferably greater than or equal to DN250 and particularly preferably greater than or equal to DN300.

Tests on the nominal diameter of the coolant valve have shown that the nominal diameter of the coolant valve affects both the delay time and the equalization time of the cooling module; cf. also Table 3 in this regard.

The nominal diameter of the coolant valve is effectively linked to the equalization time of the cooling module. The larger the nominal diameter, the greater the designated mass of the coolant downstream of the coolant cut-off region of the coolant valve up to the at least one coolant outlet opening. With a designated change in the open state of the coolant valve, a higher inertial resistance of the cooling module results from a larger nominal diameter of the coolant valve, whereby the equalization time of the cooling module also increases as the nominal diameter of the coolant valve increases.

The delay time of the cooling module also has a causal relationship to the nominal diameter of the coolant valve. On the one hand, coolant valves with a larger nominal diameter can also have a larger coolant valve time constant, which increases the delay time of the cooling module in relation to the changed coolant time constant. On the other hand, coolant valves with a smaller nominal diameter have a larger average rate in the coolant cut-off region of the coolant valve at a designated constant coolant volume flow flowing out of the at least one coolant outlet opening. If coolant valves with different nominal diameters but the same coolant valve loss coefficient ζᵥₐₗᵥₑ are compared in this regard, this would result in greater total pressure losses of the coolant in the coolant valve with a smaller nominal diameter. Accordingly, the delay time of the cooling module with respect to the total pressure losses increases with a smaller nominal diameter.

According to a further preferred embodiment, the coolant valve has a nominal diameter of less than or equal to DN300, preferably less than or equal to DN250 and particularly preferably greater than or equal to DN120.

Preferably, the coolant valve has a nominal diameter of less than or equal to DN200, more preferably of less than or equal to DN150, preferably of less than or equal to DN80 and particularly preferably of less than or equal to DN60.

Advantageously, the coolant valve has a distance from a transition between the coolant chamber and a coolant outlet pipe of less than or equal to 500 mm, preferably less than or equal to 325 mm and particularly preferably less than or equal to 275 mm.

The distance between the coolant valve of the cooling module and the transition between the coolant chamber and the coolant outlet pipe is understood as the distance between the flange of the coolant chamber at the sealing surface of the flange for connection to the coolant valve and the center point of the transition between the coolant chamber and the coolant outlet pipe.

Coolant chambers having a plurality of coolant outlet pipes may be constructed such that the coolant outlet pipes are arranged one after the other or in successive pairs in the longitudinal direction of extension of the coolant chamber. In a corresponding embodiment comprising a plurality of coolant outlet pipes, the distance refers to the transition to a coolant outlet pipe that is closest to the valve flange.

Preferably, the coolant valve has a distance from a transition between the coolant chamber and a coolant outlet pipe of less than or equal to 750 mm, more preferably of less than or equal to 625 mm, preferably of less than or equal to 400 mm and particularly preferably of less than or equal to 250 mm.

A transition between the coolant chamber and a coolant outlet pipe is expediently well rounded, in particular having a transition loss coefficient ζₜᵣₐₙₛᵢₜᵢₒₙ of less than or equal to 0.3, preferably of less than or equal to 0.15 and particularly preferably of less than or equal to 0.08.

In this regard, the following is explained conceptually:

A “transition” between the coolant chamber and a coolant outlet pipe is understood to mean the smallest free cross section through which a designated coolant emanating from the coolant chamber must flow in order to flow into a coolant outlet pipe. The transition can be arranged directly at the base of the coolant outlet pipe.

The transition loss coefficient ζₜᵣₐₙₛᵢₜᵢₒₙ can be determined as follows:

$${ζ}_{transition} = \frac{2 \cdot Δ p}{ρ \cdot {\overline{v}}_{transition}^{2}}$$

$${\overline{v}}_{transition}^{2}$$

is understood to mean the square of the area-averaged coolant rate in the reference cross section of the transition, in particular in the smallest free cross section through which a designated coolant emanating from the coolant chamber must pass in order to be able to flow into a coolant outlet pipe. Δp describes the absolute pressure loss when coolant flows through the transition and ρ describes the density of the coolant.

The smallest free cross section through which a designated coolant emanating from the coolant chamber must pass in order to be able to flow into a coolant outlet pipe may correspond to the cross-sectional area of the coolant outlet pipe.

A well-rounded transition can be designed as an aperture. In particular, with a plurality of coolant outlet pipes emanating from a coolant chamber, hydraulic balancing can be achieved by varying free cross sections of the individual transitions to the individual coolant outlet pipes, so that substantially the same coolant volume flow can flow out of each associated coolant outlet opening in a designated fashion, whereby the homogeneity of the microstructure can be improved, in particular in the lateral direction of extension of the metal strip-shaped product.

Preferably, a transition between the coolant chamber and a coolant outlet pipe is designed to have a transition loss coefficient ζₜᵣₐₙₛᵢₜᵢₒₙ of less than or equal to 0.4, preferably of less than or equal to 0.22 and particularly preferably of less than or equal to 0.11.

Tests have shown that the transition loss coefficient ζₜᵣₐₙₛᵢₜᵢₒₙ may be effectively linked to the delay time of the cooling module, wherein a smaller transition loss coefficient may reduce the delay time of the cooling module.

The cooling module optionally comprises a flowmeter.

A flowmeter is designed to measure a coolant rate and/or a coolant volume flow. A flowmeter can interact tactilely with a designated coolant or function without contact with the coolant.

A flowmeter can be designed as a structural unit with the coolant valve and/or be operatively connected to the coolant chamber and/or at least one coolant outlet pipe.

The flowmeter proposed here can provide an actual value for a coolant rate and/or a coolant volume flow, which can be used for controlling the cooling module using open-loop and/or closed-loop control.

According to an optional embodiment, the cooling module can have an outlet for a bypass channel, in particular one that is in direct fluid communication with the coolant feed and/or direct fluid communication with the coolant chamber.

In this regard, the following is explained conceptually:

An “outlet” in the cooling module is understood to mean a free cross section that differs from a coolant outlet opening, through which a designated coolant can flow out of the cooling module, in particular into a bypass channel, without cooling the metal strip-shaped product. In other words, a coolant volume flow can flow through an outlet which is not directly intended to cool the metal strip-shaped product.

The outlet can be arranged upstream or downstream of the coolant valve in the designated flow direction of the coolant.

If the outlet is arranged upstream of the coolant valve, a coolant volume flow can be in motion in the coolant feed until it reaches the outlet, even if the coolant valve is closed and the cooling module is therefore not being used to cool a metal strip-shaped product. When the coolant valve is open, direct use can be made of the coolant that is already in motion, wherein the coolant is at least partially redirected from the outlet and through the coolant valve and thus has to have a smaller overall acceleration value to achieve the desired coolant rate. Coupled with the inertial resistance of the cooling module, the moving coolant is effectively linked to the equalization time of the cooling module so that the equalization time of the cooling module can be advantageously reduced by an outlet in the cooling module.

In order to avoid having to discard the coolant flowing out through the outlet, the outlet is preferably in fluid communication with a “bypass channel” which is designed to feed the coolant at least indirectly back into the coolant reservoir and/or a main coolant feed and/or a cooling group branch and/or a coolant feed.

Preferably, the bypass channel is in fluid communication with a coolant conveying device which is configured to convey the coolant into the coolant reservoir and/or a main coolant feed and/or a cooling group branch and/or a coolant feed. This can advantageously compensate for coolant circuit pressure losses.

The outlet is expediently fluidically connected to a bypass valve.

In this regard, the following is explained conceptually:

A “bypass valve” is understood to mean a valve that is designed to control a designated coolant volume flow flowing through the bypass channel using open-loop and/or closed-loop control.

The interaction between the coolant valve and the bypass valve advantageously allows for high dynamics of the coolant volume flow to be maintained in the cooling module, even if the cooling module is not currently being used to cool the metal strip-shaped product.

The bypass valve can be controlled using open-loop and/or closed-loop control by an electronic open-loop and/or closed-loop control unit.

As a result, in the cooling module not currently being used for cooling the metal strip-shaped product, a smaller total pressure difference of the coolant can be advantageously achieved at least in subregions of the cooling module, whereby the delay time of the cooling module can be reduced. In addition, in the cooling module not currently being used to cool the metal strip-shaped product, a higher coolant rate can be achieved at least in subregions of the cooling module, whereby the inertial resistance and thus the equalization time of the cooling module can be reduced.

A cooling module that is not currently being used to cool the metal strip-shaped product is understood to mean that the designated coolant rate of a coolant outlet opening is substantially zero.

According to a preferred embodiment, the cooling module comprises—at least two cooling bars each having a coolant chamber and a plurality of coolant outlet pipes that are connected to the coolant chamber in order to fluidically communicate therewith and each have at least
one coolant outlet opening for applying the coolant to the strip-shaped product; and a cooling module branch that fluidically communicates with the at least two cooling bars.

In this regard, the following is explained conceptually:
A “cooling module branch” means a flow divider in the inflow region to a plurality of cooling bars. A designated coolant volume flow can be divided by the cooling module branch to a plurality of cooling bars, in particular to two, three, four, five or more cooling bars. Preferably, the coolant volume flow is divided into substantially equal parts.

The cooling module branch can be configured to be connected to a coolant reservoir so as to at least indirectly fluidically communicate therewith.

Here, a cooling module is proposed which has a cooling module branch downstream of the coolant valve. Preferably, the cooling module branch is integrally formed with the plurality of cooling bars.

Preferably, the cooling module branch has a cooling module branch loss coefficient ζ_{module branch} of less than or equal to 0.2, preferably less than or equal to 0.15 and particularly preferably less than or equal to 0.11.

Further preferably, the cooling module branch has a cooling module branch loss coefficient ζ_{module branch} of less than or equal to 0.3, preferably less than or equal to 0.25 and particularly preferably less than or equal to 0.08.

In this regard, the following is explained conceptually:

The cooling module branch loss coefficient (module branch can be determined as follows:

$${ζ}_{module branch} = \frac{2 \cdot Δ p}{ρ \cdot {\overline{v}}_{module branch}^{2}}$$

$${\overline{v}}_{module branch}^{2}$$

is understood to mean the square of the area-averaged coolant rate in the reference cross section of the cooling module branch, in particular in the total free cross section of the individual branches directly at the level of the flow divider through which the designated coolant flows. Δp describes the absolute pressure loss when coolant flows through the cooling module branch and p describes the density of the coolant.

Tests have shown that the cooling module branch loss coefficient ζ_{module} branch may be effectively linked to the delay time of the cooling module, wherein a smaller cooling module branch loss coefficient may reduce the delay time of the cooling module.

According to an expedient embodiment, a level difference between the coolant valve and at least one coolant outlet opening is less than or equal to 500 mm, preferably less than or equal to 400 mm and particularly preferably less than or equal to 250 mm.

Further preferably, the level difference between the coolant valve and at least one coolant outlet opening is less than or equal to 325 mm, preferably less than or equal to 200 mm and particularly preferably less than or equal to 175 mm.

The level difference specified here means the level difference in the direction of gravity, wherein the level reference point of the coolant valve is the center of the reference cross section of the coolant valve, in particular the center of the coolant cut-off region.

It has been found that, for a small delay time, it is advantageous if the coolant valve has a small level difference with respect to the at least one coolant outlet opening.

Preferably, a cooling module comprises an electronic open-loop and/or closed-loop control unit, wherein the electronic open-loop and/or closed-loop control unit is configured to control the cooling module using open-loop and/or closed-loop control. The electronic open-loop and/or closed-loop control unit can be configured to control at least one coolant valve using open-loop and/or closed-loop control, in particular as a function of a coolant rate and/or a coolant volume flow and/or a specific water application and/or a cooling rate and/or a microstructure of the metal strip-shaped product and/or a temperature of the metal strip-shaped product and/or a temperature curve along a conveyor line for the metal strip-shaped product.

Mechanical properties of the metal strip-shaped product and/or grain sizes of the microstructure of the metal strip-shaped product and/or phase components of the metal strip-shaped product can be determined, among other things, using laser ultrasonic methods and/or magnetic measuring techniques.

According to a second aspect of the invention, the object is achieved by a cooling group of a cooling device for cooling a hot-rolled metal strip-shaped product using a coolant, comprising:
at least two cooling modules according to the first aspect of the invention; and
a cooling group branch that fluidically communicates with the at least two cooling modules.

In this regard, the following is explained conceptually:

A “cooling group branch” is understood to mean a flow divider in the inflow region leading to a plurality of cooling modules. A designated coolant volume flow can be divided by the cooling group branch to a plurality of cooling modules, in particular to two, three, four, five or more cooling modules. Preferably, the coolant volume flow is divided into substantially equal parts.

The cooling group branch can be configured for connection to a coolant reservoir so as to at least indirectly fluidically communicate therewith.

Here, a cooling group is proposed which has a plurality of cooling modules and a common coolant supply such that the coolant can be divided onto the plurality of cooling modules in a designated manner by the cooling group branch.

Preferably, a cooling group has a bypass outlet upstream of the cooling group branch, wherein the bypass outlet can be configured to return the coolant to the coolant reservoir and/or the main coolant feed.

The cooling group may have a flowmeter, in particular upstream of the cooling group branch.

It goes without saying that the advantages of a cooling module according to the first aspect of the invention extend to a cooling group having at least two cooling modules according to the first aspect of the invention, as described above.

Preferably, the cooling group branch has a cooling group branch loss coefficient ζ_{group branch} of less than or equal to 0.2, preferably less than or equal to 0.15 and particularly preferably less than or equal to 0.11.

Further preferably, the cooling group branch has a cooling group branch loss coefficient ζ_{group branch} of less than or equal to 0.3, preferably less than or equal to 0.25 and particularly preferably less than or equal to 0.08.

In this regard, the following is explained conceptually:

The cooling group branch loss coefficient ζ_{group branch} can be determined as follows:

$${ζ}_{group branch} = \frac{2 \cdot Δ p}{ρ \cdot {\overline{v}}_{module branch}^{2}}$$

$${\overline{v}}_{group branch}^{2}$$

is understood to mean the square of the area-averaged coolant rate in the reference cross section of the cooling group branch, in particular in the total free cross section of the individual branches directly at the level of the flow divider through which the designated coolant flows. Ap describes the absolute pressure loss when coolant flows through the cooling group branch and p describes the density of the coolant.

During tests with a cooling group as proposed here, it was found that the cooling group branch loss coefficient ζ_{group branch} can be effectively linked to the delay time of the cooling modules connected for fluid communication, wherein a smaller cooling group branch loss coefficient can reduce the delay time of a cooling module.

Preferably, a cooling group has an electronic open-loop and/or closed-loop control unit, wherein the electronic open-loop and/or closed-loop control unit is configured to control the cooling group using open-loop and/or closed-loop control. The electronic open-loop and/or closed-loop control unit can be configured to control at least one coolant valve using open-loop and/or closed-loop control, in particular as a function of a coolant rate and/or a coolant volume flow and/or a specific water application and/or a cooling rate and/or a microstructure of the metal strip-shaped product and/or a temperature of the metal strip-shaped product and/or a temperature curve along a conveyor line for the metal strip-shaped product.

It should be expressly noted that the subject matter of the second aspect can advantageously be combined with the subject matter of the preceding aspect of the invention, both individually or cumulatively in any combination.

According to a third aspect of the invention, the object is achieved by a cooling system for cooling a hot-rolled metal strip-shaped product using a coolant, comprising:
a cooling device;
at least one cooling module according to the first aspect of the invention and/or at least one cooling group according to the second aspect of the invention; and
a coolant reservoir that fluidically communicates with a main coolant feed, wherein the main coolant feed fluidically communicates with the at least one cooling module and/or the at least one cooling group.

In this regard, the following is explained conceptually:

A “main coolant feed” means a fluid connection located downstream of the coolant reservoir and upstream of a cooling group and/or cooling module.

Preferably, the main coolant feed has an internal diameter of greater than or equal to 0.6 m, preferably greater than or equal to 0.9 m and particularly preferably greater than or equal to 1.3 m. The main coolant feed may have a free cross-sectional area normal to the designated flow direction of the coolant of greater than or equal to 0.28 m², preferably greater than or equal to 0.63 m² and particularly preferably greater than or equal to 1.32 m².

Here, a cooling system for actively cooling a hot-rolled metal strip-shaped product using a coolant is now proposed, which cooling system comprises at least one cooling module according to the first aspect of the invention and/or at least one cooling group according to the second aspect of the invention, wherein the at least one cooling module and/or the at least one cooling group is connected using a main coolant feed to a coolant reservoir for at least indirect fluid communication therewith.

The cooling system may have an electronic open-loop and/or closed-loop control unit, preferably a master open-loop and/or closed-loop control unit.

An “electronic open-loop and/or closed-loop control unit” is understood to mean a device which is designed to monitor and/or control, using open-loop and/or closed-loop control, the cooling system, in particular as a function of a coolant rate and/or a coolant volume flow and/or a specific water application and/or a cooling rate and/or a microstructure of the metal strip-shaped product.

The electronic control and/or regulating unit may have an interface for receiving data, an interface for transmitting data and a device for processing data. In particular, the data processing apparatus can be designed to execute an algorithm, in particular implementing a method according to a fourth aspect of the invention. Preferably, the electronic control and/or regulating unit can have a device for storing data, in particular a data memory.

It goes without saying that the advantages of a cooling module according to the first aspect of the invention and/or a cooling group according to the second aspect of the invention, as described above, extend directly to a cooling system having a cooling module according to the first aspect of the invention and/or a cooling group according to the second aspect of the invention.

Particularly preferably, the cooling system is designed for a pressure difference between the coolant reservoir and the coolant outlet opening of greater than or equal to 3·10⁴ kg/(m·s²), preferably greater than or equal to 4·10⁴ kg/(m·s²), more preferably greater than or equal to 4.5·10⁴ kg/(m·s²). and particularly preferably greater than or equal to 5·10⁴ kg/(m·s²).

The cooling system can be designed for a pressure difference between the coolant reservoir and the coolant outlet opening of greater than or equal to 5.5·10⁴ kg/(m·s²), preferably greater than or equal to 6·10⁴ kg/(m·s²), preferably greater than or equal to 6.5·10⁴ kg/(m·s²) and particularly preferably greater than or equal to 7·10⁴ kg/(m·s²).

The values for the pressure difference specified here allow particularly short delay times to be achieved for the at least one cooling module and/or the at least one cooling group. Tests have shown that the delay time can be reduced as the pressure difference increases while all other conditions remain the same.

According to a preferred embodiment, the cooling system is designed for a specific water application of greater than or equal to 20·m³/(m²·h), preferably greater than or equal to 50·m³/(m²·h), more preferably greater than or equal to 100·m³/(m²·h) and particularly preferably greater than or equal to 150·m³/(m²·h).

The cooling system can be designed for a specific water application of greater than or equal to 75·m³/(m²·h), preferably greater than or equal to 125·m³/(m²·h), more preferably greater than or equal to 175·m³/(m²·h) and particularly preferably greater than or equal to 200·m³/(m²·h).

In this regard, the following is explained conceptually:

A “specific water application” is understood to mean a variable of coolant, with respect to a surface of the metal strip-shaped product and with respect to a time unit of an active cooling process, which can be applied by the cooling system to the metal strip-shaped product to actively cool it. In particular, the specific water application is understood to mean the time- and/or area-averaged water application.

The cooling system is particularly preferably designed for a cooling rate of greater than or equal to 50·K/(s·mm), preferably greater than or equal to 200·K/(s·mm), more preferably greater than or equal to 300·K/(s·mm) and particularly preferably greater than or equal to 500·K/(s·mm).

The cooling system can be designed for a cooling rate greater than or equal to 100·K/(s·mm), preferably greater than or equal to 150·K/(s·mm), more preferably greater than or equal to 250·K/(s·mm) and particularly preferably greater than or equal to 400·K/(s·mm).

According to a particularly expedient embodiment, the cooling system comprises at least a first cooling bar and a second cooling bar, wherein the first cooling bar is configured to apply the coolant to the top of the strip-shaped product and the second cooling bar is configured to apply the coolant to the bottom of the strip-shaped product.

With the proposed cooling system, coolant can be simultaneously applied to a metal strip-shaped product from both sides of the strip, which can advantageously increase the cooling rate.

Optionally, the cooling system comprises a main coolant conveying device configured to increase the pressure difference between the coolant reservoir and the coolant outlet opening.

In this regard, the following is explained conceptually:

A “main coolant conveying device” is understood to mean an active conveying device which is directly equipped with a coolant at the transition to the main coolant feed and/or in the main coolant feed.

With the main coolant conveying device proposed here, the pressure difference can be increased and thus the delay time for the at least one cooling module and/or the at least one cooling group can be reduced.

It should be expressly noted that the subject-matter of the third aspect can advantageously be combined with the subject-matter of the preceding aspects of the invention, both individually and cumulatively in any combination.

According to a fourth aspect of the invention, the object is achieved by a method for actively cooling a hot-rolled metal strip-shaped product, wherein a cooling module according to the first aspect of the invention and/or a cooling group according to the second aspect of the invention and/or a cooling system according to the third aspect of the invention is used for actively cooling the hot-rolled metal strip-shaped product.

Preferably, the method involves controlling the at least one cooling module and/or the at least one cooling group and/or the at least one cooling system using open-loop and/or closed-loop control, wherein at least one coolant valve and/or at least one bypass valve and/or at least one coolant conveying device and/or at least one main coolant conveying device is controlled using open-loop and/or closed-loop control. Open-loop and/or closed-loop control can be designed in particular as a function of a coolant rate and/or a coolant volume flow and/or a specific water application and/or a cooling rate and/or a microstructure of the metal strip-shaped product and/or a temperature of the metal strip-shaped product and/or a temperature curve along a conveyor line for the metal strip-shaped product.

It should be expressly noted that the subject-matter of the fourth aspect can advantageously be combined with the subject-matter of the preceding aspects of the invention, both individually and cumulatively in any combination.

According to a preferred embodiment, the method is designed to control a degree of division of at least one microstructure component using open-loop and/or closed-loop control, in particular to achieve a degree of division of greater than or equal to 0.85, preferably greater than or equal to 0.9 and particularly preferably greater than or equal to 0.95.

Here, a method for actively cooling the hot-rolled metal strip-shaped product is proposed, which is designed to control the homogeneity of the microstructure using open-loop and/or closed-loop control, wherein the homogeneity of the microstructure can be determined by the degree of division of at least one microstructure component. It is provided that the method at least indirectly records the microstructure and uses at least one of the above-described manipulated variables of the cooling module and/or the cooling group and/or the cooling system to control the degree of division of at least one microstructure component using open-loop and/or closed-loop control.

Preferably, the method controls the degrees of division of two or three or four or more microstructure components using open-loop and/or closed-loop control.

Preferably, a degree of division of greater than or equal to 0.875, more preferably a degree of division of greater than or equal to 0.925, preferably greater than or equal to 0.97 and particularly preferably greater than or equal to 0.98 is achieved.

The method is expediently designed to reduce a head length of the metal strip-shaped product, in particular to achieve a head length of less than or equal to 10 m, preferably less than or equal to 8 m and particularly preferably less than or equal to 6 m.

The “head length” is understood to mean the front longitudinal portion of the metal strip-shaped product, the microstructure of which is not yet homogeneous enough so that at least one of the mechanical properties required for the metal strip-shaped product is not achieved in the region of the head length.

Further expediently, the method is designed to reduce a foot length of the metal strip-shaped product, in particular to achieve a foot length of less than or equal to 10 m, preferably less than or equal to 8 m and particularly preferably less than or equal to 6 m.

The “foot length” is understood to mean the rear longitudinal portion of the metal strip-shaped product, the microstructure of which is not homogeneous enough so that at least one of the mechanical properties required for the metal strip-shaped product is not achieved in the region of the foot length.

It should be expressly noted that the subject-matter of the fourth aspect can advantageously be combined with the subject-matter of the preceding aspects of the invention, both individually and cumulatively in any combination.

According to a fifth aspect of the invention, the object is achieved by a hot-rolled metal strip-shaped product produced using a method according to the fourth aspect of the invention, in particular a hot-rolled metal product having a tensile strength of greater than or equal to 560 N/mm² and a manganese content of less than 1.5 wt. % and a niobium content of less than 0.05 wt. %.

Preferably, the manganese content of the hot-rolled metal strip-shaped product is less than or equal to 1.45 wt. %, more preferably less than or equal to 1.4 wt. %, preferably less than or equal to 1.35 wt. % and particularly preferably less than or equal to 1.2 wt. %.

Preferably, the niobium content of the hot-rolled metal strip-shaped product is less than or equal to 0.045 wt. %, more preferably less than or equal to 0.04 wt. %, preferably less than or equal to 0.035 wt. % and particularly preferably less than or equal to 0.03 wt. %.

Preferably, the tensile strength of the hot-rolled metal strip-shaped product is greater than or equal to 565 N/mm², more preferably greater than or equal to 570 N/mm², preferably greater than or equal to 575 N/mm² and particularly preferably greater than or equal to 580 N/mm².

It will be understood that the advantages of a method according to the fourth aspect of the invention, as described above, extend to a hot-rolled metal product produced by the method.

It should be expressly noted that the subject-matter of the fifth aspect can advantageously be combined with the subject-matter of the preceding aspects of the invention, both individually and cumulatively in any combination.

According to a sixth aspect of the invention, the object is achieved by the use of a cooling module according to the first aspect of the invention and/or a cooling group according to the second aspect of the invention and/or a cooling system according to the third aspect of the invention and/or a method according to the fourth aspect of the invention for actively cooling a hot-rolled metal strip-shaped product using a coolant.

It goes without saying that the advantages of a cooling module according to the first aspect of the invention and/or a cooling group according to the second aspect of the invention and/or a cooling system according to the third aspect of the invention and/or a method according to the fourth aspect of the invention, as described above, extend directly to the use of a cooling module according to the first aspect of the invention and/or a cooling group according to the second aspect of the invention and/or a cooling system according to the third aspect of the invention and/or a method according to the fourth aspect of the invention for cooling a hot-rolled metal strip-shaped product.

It should be expressly noted that the subject matter of the sixth aspect can advantageously be combined with the subject matter of the preceding aspects of the invention, specifically individually or cumulatively in any combination.

Further advantages, details, and features of the invention can be found below in the described exemplary embodiments. In the figures, in detail:

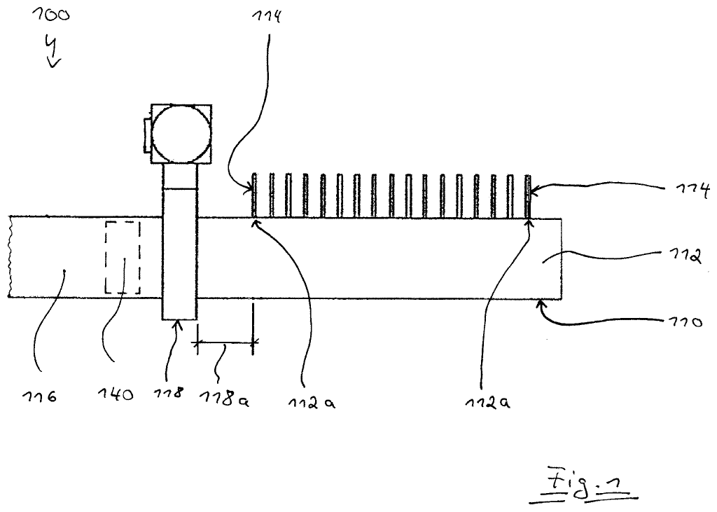

FIG. 1 is a schematic view of a cooling module according to a first embodiment;

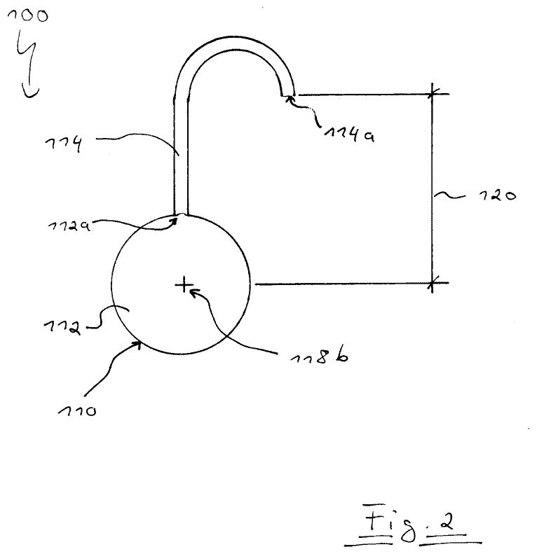

FIG. 2 is a schematic sectional view through a cooling module;

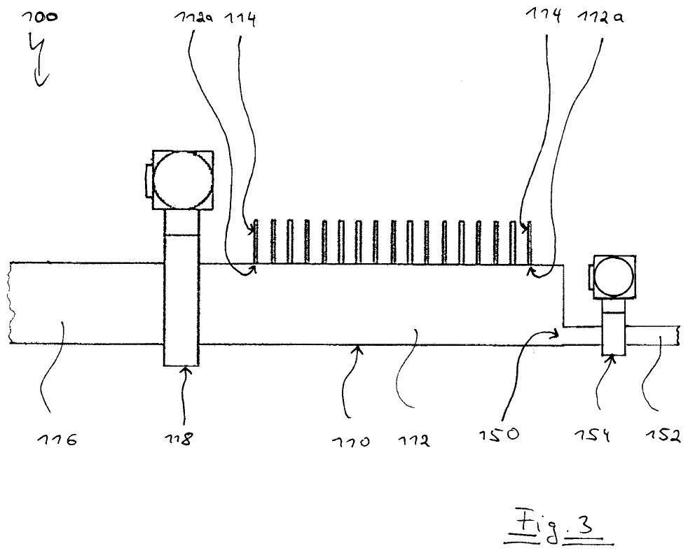

FIG. 3 is a schematic view of a cooling module according to a second embodiment;

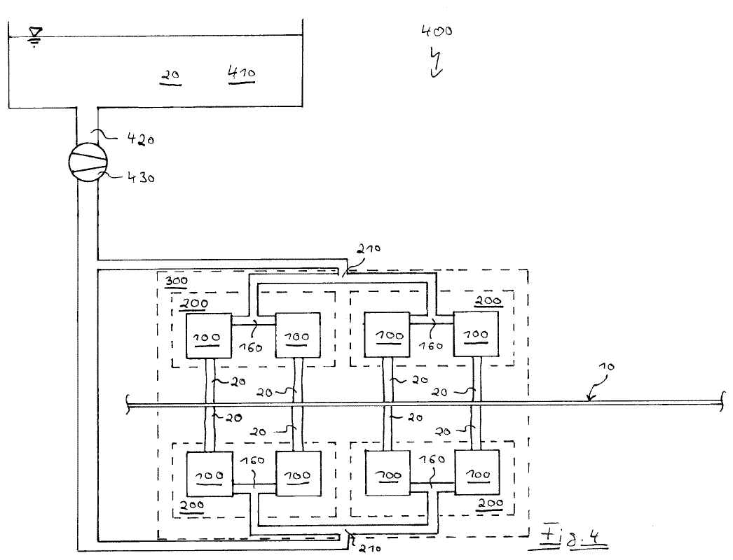

FIG. 4 is a schematic view of a cooling system;

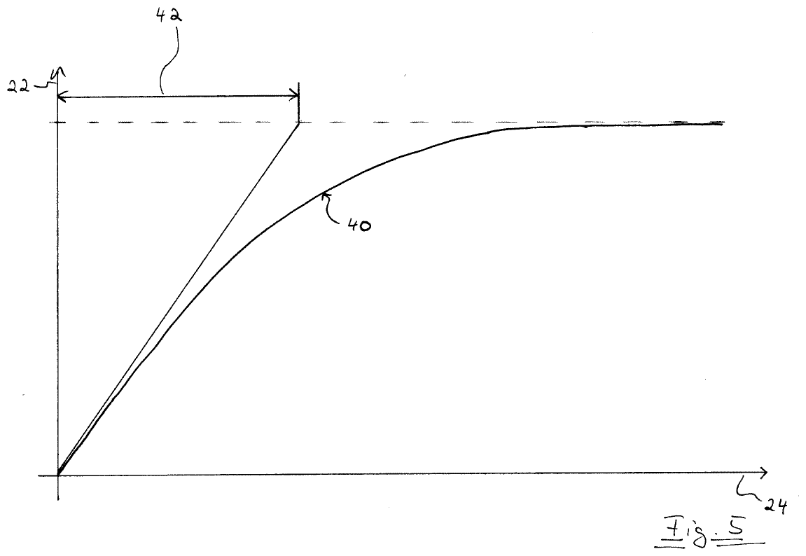

FIG. 5 is a schematic view of a time-variant coolant valve step function; and

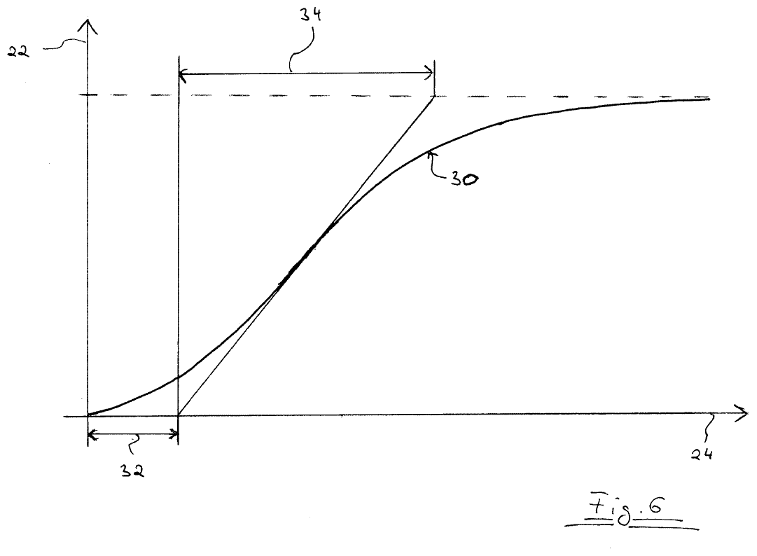

FIG. 6 is a schematic view of a time-variant step function of a cooling module.

In the following description, the same reference signs denote the same components or features; in the interest of avoiding repetition, a description of a component made with reference to one drawing also applies to the other drawings. Furthermore, individual features that have been described in connection with one embodiment can also be used separately in other embodiments.

The cooling module 100 in FIG. 1 substantially consists of a cooling bar 110, a coolant feed 116 and a coolant valve 118.

The cooling module 100 can be a component of a cooling device (not shown) for cooling a hot-rolled metal strip-shaped product (not shown) using a coolant (not shown), wherein the coolant can be allowed to leave the cooling module 100 in a designated manner and, after being allowed to leave, can form an operative connection with the strip-shaped product, in particular with the hot-rolled metal strip-shaped product, so as to cool it.

The cooling bar 110 has a coolant chamber 112 and a plurality of coolant outlet pipes 114 (only some of which are labeled) connected to the coolant chamber 112 so as to fluidically communicate therewith. Each coolant outlet pipe 114 has at least one coolant outlet opening (not labeled) for applying the coolant to the strip-shaped product.

The coolant chamber 112 is at least indirectly fluidically connected to the coolant feed 116 so as to fluidically communicate therewith. In particular, the coolant valve 118 is arranged between the coolant feed 116 and the coolant chamber 112.

The coolant feed 116 is configured for connection to a coolant reservoir (not shown) so as to at least indirectly fluidically communicate therewith, wherein the coolant reservoir is configured to provide a pressure difference between the coolant reservoir and the at least one coolant outlet opening (not labeled).

The cooling module 100 comprises a transition 112a between the coolant chamber 112 and a coolant outlet pipe 114, wherein this transition 112a is preferably well rounded, in particular having a transition loss coefficient ζₜᵣₐₙₛᵢₜᵢₒₙ of less than or equal to 0.3, preferably of less than or equal to 0.15 and particularly preferably of less than or equal to 0.08.

It goes without saying that a transition 112a is provided between each coolant outlet pipe 114 and the coolant chamber 112.

The coolant valve 118 has a distance 118a from a transition between the coolant chamber 112 and a coolant outlet pipe 114 of less than or equal to 500 mm, preferably less than or equal to 325 mm and particularly preferably less than or equal to 275 mm. The distance 118a between the coolant valve 118 of the cooling module 100 and the transition 112a between the coolant chamber 112 and the coolant outlet pipe 114 is understood as the distance 118a between a flange (not labeled/not shown) of the coolant chamber 112 at a sealing surface (not labeled/not shown) of the flange for connection to the coolant valve 118 and a center point (not labeled) of the transition 112a between the coolant chamber 112 and the coolant outlet pipe 114.

It goes without saying that the distance 118a is understood to be the distance 118a which is the shortest among the plurality of coolant outlet pipes 114, i.e., from the closest coolant outlet pipe 114 when viewed from the coolant valve 118.

The cooling module 100 may have a flowmeter 140 (shown schematically), in particular in the form of a tactile or a non-tactile flowmeter 140. The flowmeter 140 can be arranged in the coolant feed 116, in the coolant valve 118 or downstream of the coolant valve 118 and upstream of the coolant outlet pipe 114 that is closest to the coolant valve 118 in the coolant chamber 112.

A sectional view through a cooling module 100 according to FIG. 1 can be seen in FIG. 2.

The coolant chamber 112 of the cooling bar 110 of the cooling module 100 comprises a transition 112a to a coolant outlet pipe 114.

The coolant outlet pipe 114 comprises a coolant outlet opening 114a through which a coolant (not shown) can exit.

Between a level reference point 118b of the coolant valve 118 and the coolant outlet opening 114a there is a level difference 120 in the direction of gravity (not shown). The level difference 120 can be less than or equal to 500 mm, preferably less than or equal to 400 mm and particularly preferably less than or equal to 250 mm.

The cooling module 100 in FIG. 3 has an outlet 150 for a bypass channel 152, wherein the outlet 150 is designed to be in direct fluid communication with the coolant chamber 112.

The outlet 150 is fluidly connected to a bypass valve 154 and can be opened and closed by means of the bypass valve 154.

A cooling system 400, as in FIG. 4, substantially consists of a cooling device 300 for cooling a metal strip-shaped product 10 by means of a coolant 20, a coolant reservoir 410 for storing the coolant 20, a cooling device 300 for applying the coolant 20 to the metal strip-shaped product 10, and a main coolant feed 420 for fluidically connecting the coolant reservoir 410 to the cooling device 300.

The cooling system 400 may comprise a main coolant conveying device 430 for increasing the total pressure of the coolant 20 in the cooling device 300.

It is provided that the metal strip-shaped product 10 can be conveyed on a conveyor line (not labeled) in a transport direction (not shown) in such a way that it can be operatively connected to the cooling device 300, in particular by an operative connection with a liquid coolant 20 leaving the cooling device 300 in a designated fashion. For this purpose, the metal strip-shaped product 10 can be conveyed past at least one cooling module 100 of the cooling device 300 and/or between at least two cooling modules 100 of the cooling device 300.

The cooling device 300 can have at least one cooling module 100 arranged above the metal strip-shaped product 10, in particular one or more first cooling modules 100, to which the liquid coolant 20 is supplied via the main coolant feed 420, wherein the cooling module 100 preferably extends substantially transversely to the transport direction (not labeled) and preferably has a plurality of coolant outlet pipes (not shown) via which the liquid coolant 20 can be brought into an operative connection with the metal strip-shaped product 10.

Analogously, the cooling device 300 can have at least one cooling module 100 arranged below the metal strip-shaped product 10, in particular one or more second cooling modules 100, which is/are configured to bring the liquid coolant 20 into an operative connection with the metal strip-shaped product 10.

In the conveying direction of the metal strip-shaped product 10, the cooling device 300 can have a plurality of cooling modules 100, which can be arranged above and/or below the metal strip-shaped product 10.

One or more cooling modules 100 can be arranged in a cooling device 300 in one or more cooling groups 200.

The coolant reservoir 410 is in fluid communication with the main coolant feed 420, wherein the main coolant feed 420 is in fluid communication with the at least one cooling module 100 and/or the at least one cooling group 200.

The cooling device 300 has two cooling groups 200 arranged above the metal strip-shaped product 10, which are fluidically connected to the main coolant feed 420 by means of a cooling group branch 210 that is also arranged above the metal strip-shaped product 10.

The cooling device 300 has two cooling groups 200 arranged below the metal strip-shaped product 10, which are fluidically connected to the main coolant feed 420 by means of a cooling group branch 210 that is also arranged below the metal strip-shaped product 10.

Each cooling group 200 has two cooling modules 100, each of which is fluidically connected to a cooling group branch by means of a cooling module branch 160.

The cooling system 400 can be designed for a specific water application of greater than or equal to 20·m³/(m²·h), preferably greater than or equal to 50·m³/(m²·h) and particularly preferably greater than or equal to 150·m³/(m²·h).

The cooling system 400 can be configured for a cooling rate of greater than or equal to 50·K/(s·mm), preferably greater than or equal to 200·K/(s·mm) and particularly preferably greater than or equal to 500·K/(s·mm).

The coolant valve step function 40 in FIG. 5 describes a temporal progression of a coolant rate 22 immediately downstream of a coolant valve (not shown) or in the narrowest cross section (not shown) of the coolant valve over time 24 after the coolant valve is opened in a step-like manner. The origin of the coolant valve step function 40 describes the time at which the coolant valve is opened in a step-like manner and the coolant rate 22 is zero.

The coolant valve step function 40 can describe the time-variant system behavior of a coolant valve (not shown) after the coolant valve (not shown) is opened in a step-like manner.

When the coolant valve is opened, the coolant rate 22 converges toward a constant value (not labeled) of the coolant rate 22 immediately downstream of the coolant valve or in the narrowest cross section of the coolant valve.

The coolant valve step function 40 can alternatively be described and/or characterized by means of a coolant valve time constant 42, wherein the coolant valve time constant 42 can be determined graphically from the coolant valve step function 40 by determining a time from an intersection point (not labeled) of a tangent (not labeled) at the origin of the coolant valve step function 40 with the value of the coolant rate 22 toward which the coolant valve step function 40 converges and determining a time difference between this intersection point and the time when the coolant valve is opened in a step-like manner.

The step function 30 of a cooling module (not shown) as in FIG. 6 describes a temporal progression of a coolant rate 22 in a coolant outlet opening (not shown) over time 24 after a coolant valve (not shown) has been opened in a step-like manner. The origin of the coolant valve step function 40 describes the time at which the coolant valve is opened in a step-like manner and the coolant rate 22 is zero.

The step function 30 can describe the time-variant system behavior of a cooling module (not shown) after the coolant valve (not shown) has been opened in a step-like manner.

As the coolant valve is opened, the coolant rate 22 in the coolant outlet opening converges toward a constant value (not labeled) of the coolant rate 22.

The step function 30 can alternatively be described and/or characterized by means of a delay time 32 and a equalization time 34, wherein the delay time 32 and the equalization time 34 can be determined graphically from the step function 30.

The delay time 32 can represent a measure of the higher-order influences on the time-variant system behavior of the cooling module and results from the time-variant step function 30 by means of the following steps:
determining an inflection point (not labeled) of the time-variant step function 30, in particular the coolant rate 22
drawing a tangent (not labeled) through the inflection point of the time-variant step function 30, and
determining the delay time 32 as the difference between the time (not labeled) at which the tangent intersects the abscissa (time axis) and the time (not labeled) of the step-like change in the manipulated variable, in particular of the coolant valve being opened in a step-like manner.

The equalization time 34 can be a measure of the inertia of the time-variant system behavior, i.e., a measure of the first-order influences on the time-variant system behavior, and results from the time-variant step function 30 by means of the following steps:
determining an inflection point (not labeled) of the time-variant step function 30, in particular of the coolant rate 22,
drawing a tangent (not labeled) through the inflection point of the time-variant step function 30;
determining an asymptote for the steady state of the time-variant step function 30 that results after the step-like change in the manipulated variable; and
determining the equalization time 34 as the difference between the time at which the tangent intersects the asymptote and the time at which the tangent intersects the abscissa.

### LIST OF REFERENCE SIGNS

10 metal strip-shaped product
20 coolant
22 coolant rate
24 time
30 step function
32 delay time
34 equalization time
40 coolant valve step function
42 coolant valve time constant
100 cooling module
110 cooling bar
112 coolant chamber
112a transition
114 coolant outlet pipe
114a coolant outlet opening
116 coolant feed
118 coolant valve
118a distance
118b level reference point
120 level difference
140 flowmeter
150 outlet
152 bypass channel
154 bypass valve
160 cooling module branch
200 cooling group
210 cooling group branch
300 cooling device
400 cooling system
410 coolant reservoir
420 main coolant feed
430 main coolant conveying device
ζᵥₐₗᵥₑ coolant valve loss coefficient
ζₜᵣₐₙₛᵢₜᵢₒₙ transition loss coefficient
ζ_{module branch} cooling module branch loss coefficient
ζ_{group branch} cooling group branch loss coefficient

1. A cooling module of a cooling device for cooling a hot-rolled metal strip-shaped product using a coolant (20), the cooling module comprising:
at least one cooling bar having comprising a coolant chamber and a plurality of coolant outlet pipes that are connected to the coolant chamber so as to fluidically communicate therewith and each of the plurality of coolant outlet pipes define at least one coolant outlet opening for applying the coolant to the strip-shaped product;
at least one coolant feed connected to the coolant chamber so as to at least indirectly fluidically communicate therewith, the coolant feed being configured to be connected to a coolant reservoir so as to at least indirectly fluidically communicate therewith, the coolant reservoir being configured to provide a pressure difference between the coolant reservoir and the coolant outlet opening; and
at least one coolant valve, the coolant valve being arranged between the coolant feed and the coolant chamber;
the cooling module further comprising, under the influence of the pressure difference, time-variant behavior of a coolant rate in the coolant outlet opening when the coolant valve is fully opened in a step-like manner, which behavior can be described using a time-variant step function comprising a delay time and an equalization time; wherein
the sum of the delay time and the equalization time is less than or equal to 3.0 s.

2. The cooling module according to claim 1, the coolant valve comprising, under the influence of the pressure difference, time-variant behavior of the coolant rate in the coolant chamber when the coolant valve is fully opened in a step-like manner, which behavior can be described using a time-variant coolant valve step function comprising a coolant valve time constant, wherein the coolant valve time constant is less than or equal to 1.5 s.

3. The cooling module according to either claim 1, wherein the coolant valve has comprises, when fully open, a coolant valve loss coefficient ζᵥₐₗᵥₑ of less than or equal to 0.46.

4. The cooling module according to claim 1, wherein the coolant valve comprises a nominal diameter greater than or equal to DN80.

5. The cooling module according to claim 1, wherein the coolant valve comprises a nominal diameter smaller than or equal to DN300.

6. The cooling module according to claim 1, wherein the coolant valve comprises a distance from a transition between the coolant chamber and a coolant outlet pipe of less than or equal to 500 mm.

7. The cooling module according to claim 1, wherein a transition between the coolant chamber and a coolant outlet pipe is well rounded, comprising a transition loss coefficient ζₜᵣₐₙₛᵢₜᵢₒₙ of less than or equal to 0.3.

8. The cooling module according to claim 1, wherein the cooling module further comprises a flowmeter.

9. The cooling module according claim 1, wherein the cooling module further comprises an outlet for a bypass channel that directly fluidically communicates with the coolant feed and/or directly fluidically communicates with the coolant chamber.

10. The cooling module according to claim 9, wherein the outlet is fluidically connected to a bypass valve.

11. The cooling module according to claim 1, wherein the cooling module further comprises:
at least two cooling bars, each comprising a coolant chamber, a plurality of coolant outlet pipes that are connected to the coolant chamber so as to fluidically communicate therewith, and at least one coolant outlet opening for applying the coolant to the strip-shaped product; and
a cooling module branch so as to at least indirectly fluidically communicate with the at least two cooling bars.

12. The cooling module according to claim 11, wherein the cooling module branch comprises a cooling module branch loss coefficient ζ_{module branch} of less than or equal to 0.2.

13. The cooling module according to any of the preceding claim 1, wherein a level difference (120) between the coolant valve and the at least one coolant outlet opening is less than or equal to 500 mm.

14. A cooling group of a cooling device for cooling a hot-rolled metal strip-shaped product using a coolant, the cooling group comprising:
at least two cooling modules according to claim 1; and
a cooling group branch so as to at least indirectly fluidically communicate with the at least two cooling modules.

15. The cooling group according to claim 14, wherein the cooling group branch comprises a cooling group branch loss coefficient ζ_{group branch} of less than or equal to 0.2.

16. A cooling system for cooling a hot-rolled metal strip-shaped product using a coolant, the cooling system comprising:
at least one cooling module according to claim 1; and/or
at least one cooling group comprising:
at least two cooling modules; and
a cooling group branch so as to at least indirectly fluidically communicate with the at least two cooling modules; and
a coolant reservoir that fluidically communicates with a main coolant feed, the main coolant feed fluidically communicating with the at least one cooling module and/or the at least one cooling group.

17. The cooling system according to claim 16, wherein the cooling system is configured for a pressure difference between the coolant reservoir and the coolant outlet opening of greater than or equal to 3·10⁴ kg/(m·s²).

18. The cooling system according to claim 16, wherein the cooling system is configured for a specific water application of greater than or equal to 20·m³/(m²·h).

19. The cooling system according claim 16, wherein the cooling system is configured for a cooling rate of greater than or equal to 50·K/(s·mm).

20. The cooling system according to claim 16, wherein the cooling system further comprises at least a first cooling bar and a second cooling bar, the first cooling bar being configured to apply the coolant to the top of the strip-shaped product, and the second cooling bar being configured to apply the coolant to the bottom of the strip-shaped product.

21. The cooling system according to claim 16, wherein the cooling system further comprises a main coolant conveying device configured to increase the pressure difference between the coolant reservoir and the coolant outlet opening.

22. A method for actively cooling a hot-rolled metal strip-shaped product, the method comprising:
using a cooling module according to claim 1, and/or
a cooling group comprising:
at least two cooling modules; and
a cooling group branch so as to at least indirectly fluidically communicate with the at least two cooling modules, and/or
a cooling system comprising:
at least one cooling module; and/or
at least one cooling group; and
a coolant reservoir that fluidically communicates with a main coolant feed, the main coolant feed fluidically communicating with the at least one cooling module and/or the at least one cooling group,
to cool the hot-rolled metal strip-shaped product.

23. The method for actively cooling a hot-rolled metal strip-shaped product according to claim 22, wherein the method further comprising:
controlling a degree of division of at least one microstructure component using open-loop and/or closed-loop control, in particular to achieve a degree of division of greater than or equal to 0.85.

24. The method for actively cooling a hot-rolled metal strip-shaped product according to claim 22, the method further comprising:
reducing a head length of the metal strip-shaped product to achieve a head length of less than or equal to 10 m.

25. The method for actively cooling a hot-rolled metal strip-shaped product according to claim 22, the method further comprising:
reducing a foot length of the metal strip-shaped product to achieve a foot length of less than or equal to 10 m.

26. The method for actively cooling a hot-rolled metal strip-shaped product according to claim 22, wherein the hot-rolled metal strip-shaped product comprises a tensile strength of greater than or equal to 560 N/mm² and a manganese content of less than 1.5 wt. % and a niobium content of less than 0.05 wt. %.

27. (canceled)
